(19) United States
(12) Patent Application Publication
(10) Pub. No.: US 2014/0362890 A1
(43) Pub. Date: Dec. 11, 2014

(54) MINIATURE WIRELESS ELECTRONIC THERMOMETER

(71) Applicant: LinkSens Technology Inc., Jiangsu (CN)

(72) Inventor: Dahong Qian, Jiangsu (CN)

(21) Appl. No.: 14/296,347

(22) Filed: Jun. 4, 2014

(30) Foreign Application Priority Data
Jun. 5, 2013 (CN) 201320345940

(51) Int. Cl. G01K 7/00

(52) U.S. Cl. CPC G01K 7/00
USPC 374/163

(57) ABSTRACT

A miniature wireless electronic thermometer is disclosed, the thermometer includes a medical adhesive tape serving as a securing means and a temperature measurement means attached to the securing means. The temperature measurement means includes a controller, a battery connected to the controller, a temperature sensor, and a wireless module coupled to an antenna. The thermometer is capable of convenient body temperature measurement, by allowing, when attached on human body, repeated temperature readings taken in a non-interventional manner, and sending the measurement data to an external receiver in a wireless way.

### CROSS-REFERENCES TO RELATED APPLICATIONS

This application claims the priority of Chinese patent application number 201320345940.5, filed on Jun. 5, 2013, the entire contents of which are incorporated herein by reference.

### TECHNICAL FIELD

The present invention relates to thermometers, and more particularly, to a miniature wireless electronic thermometer.

### BACKGROUND

Currently available thermometers include traditional mercury ones and modern electronic ones.

Mercury thermometers are typically designed for measuring axillary, oral, and rectal temperatures. One problem associated with the mercury thermometers is that they are cumbersome in use, in particular, in measuring the temperature of an infant or a child. In addition, the mercury thermometers also suffer from a number of other deficiencies, such as being relatively inaccurate and difficult to read.

Electronic thermometers can be divided into “contact” and “non-contact” types on terms of whether they are brought in contact with human body when in use. Examples of known electronic thermometers of the “non-contact” type include those using an infrared (IR) mechanism to detect forehead or ear temperature. Although these electronic thermometers of “non-contact” type exhibit some advantageous features, there are still several drawbacks and disadvantages associated with them, such as for example: 1) they also suffer from insufficient measurement accuracy; 2) given the fact that the forehead temperature of a human is not always synchronized with the body temperature, the forehead measurement may give results that are of less significance; and 3) ear temperature measurement requires sterilization and operational miss therein may lead to otitis media or other ear diseases. Further, Chinese Pat. No. CN101952700A discloses an electronic thermometer of the aforementioned “contact” type, as shown in FIG. 1, which includes a contact-type temperature sensor 1 adapted to be positioned under a human arm 4, a temperature housing 2 and a temperature display 3. This contact-type thermometer is disadvantageous in having a rather large size and requiring an operator to simulate the inconvenient process of using a mercury thermometer for temperature taking, i.e., reading the temperature directly from the thermometer.

Therefore, further development and improvement would be desirable for the existing electronic thermometers.

### SUMMARY OF THE INVENTION

It is therefore an objective of the present invention to provide a miniature wireless electronic thermometer which can be conveniently used in measuring body temperature and can send the measured temperature to an external receiver in a wireless fashion.

This and other objectives are attained by a miniature wireless electronic thermometer, including a temperature measurement means and a securing means configured to attach the temperature measurement means to a body part, wherein the temperature measurement means is a non-interventional means and allows repeated temperature readings, the temperature measurement means including: a temperature sensor; a controller coupled to the temperature sensor and configured to control the temperature sensor to acquire a temperature measurement data; a transmitter coupled to the controller and configured to transmit the temperature measurement data in a wireless manner; and a power supply module configured to provide power to each of the temperature sensor, the controller and the transmitter.

Preferably, the securing means may be a medical adhesive tape.

Preferably, the transmitter may include a wireless module and an antenna coupled to the wireless module.

Preferably, the power supply module may be a battery or a module capable of collecting an ambient energy.

Preferably, the temperature sensor may have a measuring accuracy of ±0.1° C. or less and a measuring range of 35° C. to 42° C.

Preferably, the thermometer may further include: a receiver configured to read the temperature measurement data in a wireless manner; and an application program installed in the receiver.

Preferably, the receiver may be a mobile phone, a laptop computer, a tablet computer, or a special reader.

Preferably, the receiver may be configured to read the temperature measurement data by means of remote control, and the application program installed in the receiver may be configured to analyze the read temperature measurement data, and automatically give an alarm if the measurement data is deviated from a preset range, or subject the temperature measurement data to storage, accumulation and further analysis if within the preset range.

Preferably, the receiver may read the temperature measurement data in a real-time manner, or a temporally random manner or a regular manner.

Preferably, the thermometer, as a whole, may be a disposable article.

Preferably, the securing means may be a disposable article, and the temperature measurement means may be a fully enclosed and entirely sterilizable structure.

Preferably, the wireless mode may be a Bluetooth or WiFi module.

From the above description, it can be understood that the miniature wireless electronic thermometer of the present invention is capable of being conveniently used in measuring body temperature. When attached on the body, it allows repeatedly temperature readings taken in a non-interventional manner and can wirelessly send the obtained body temperature data to an external receiver.

### BRIEF DESCRIPTION OF DRAWINGS

The following detailed description of the illustrative embodiments can be understood when read in conjunction with the following drawings, in which:

FIG. 1 shows how an electronic thermometer of the prior art is used.

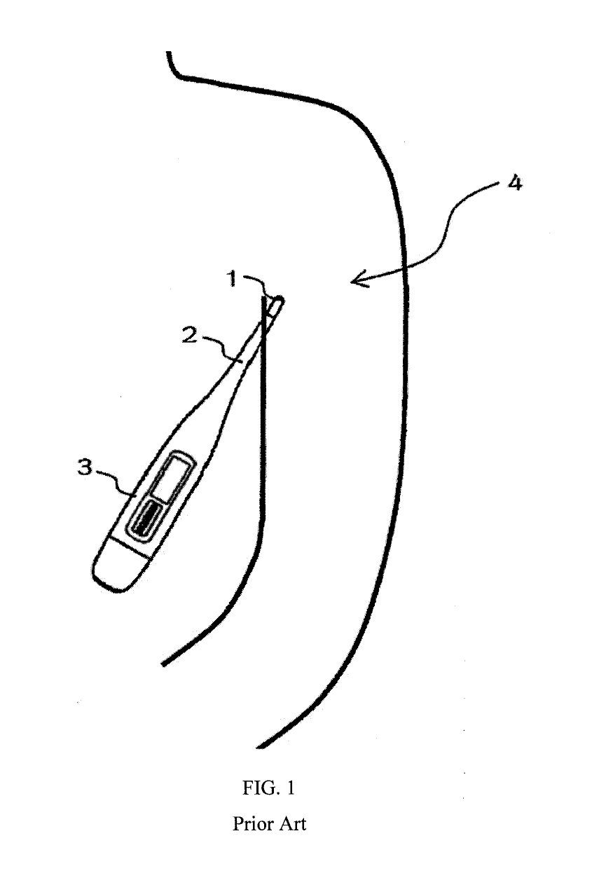

FIG. 2 shows how a miniature wireless electronic thermometer in accordance with the present invention is used.

FIG. 3 is a schematic illustration of the miniature wireless electronic thermometer of FIG. 2.

FIG. 4 shows an example of a receiver of the miniature wireless electronic thermometer of FIG. 2.

### DETAILED DESCRIPTION

### Embodiment 1

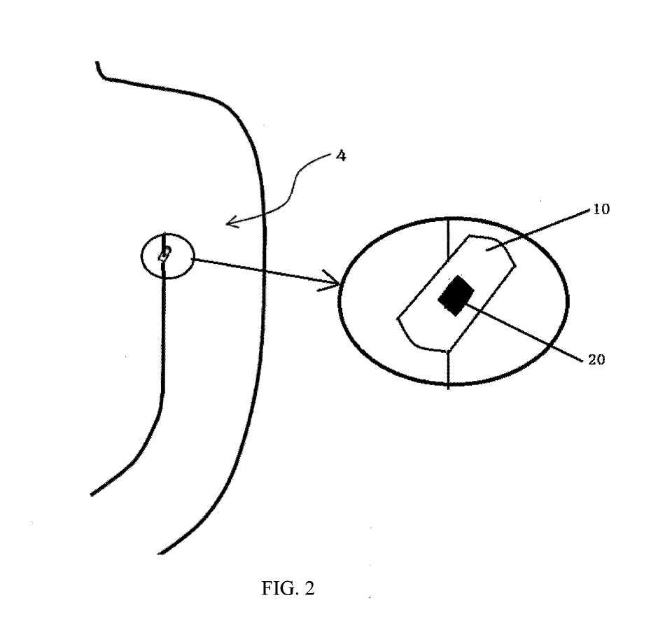

Referring to FIG. 2, when in use, the miniature wireless electronic thermometer of the present invention can be positioned under the human arm 4, as same as a traditional mercury thermometer. Further referring to the enlarged part of FIG. 2, the miniature wireless electronic thermometer is configured to be attached to a target place of the human body to be measured, and includes a securing means 10 and a temperature measurement means 20 provided on the securing means 10. The temperature measurement means 20 is non-interventional and allows repeated temperature readings. Generally, the securing means 10 may be a piece of medical adhesive tape or any other article suitable to be fixed on the human body.

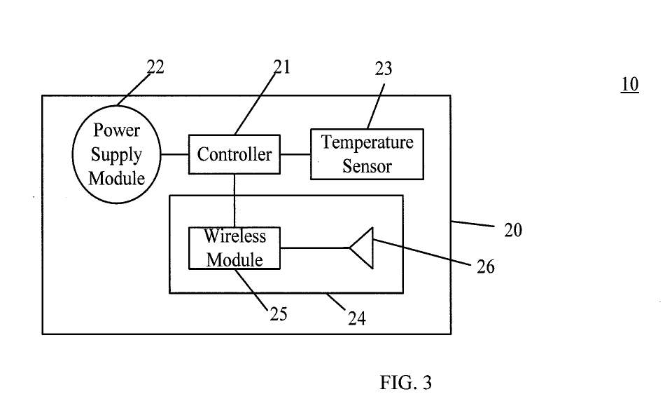

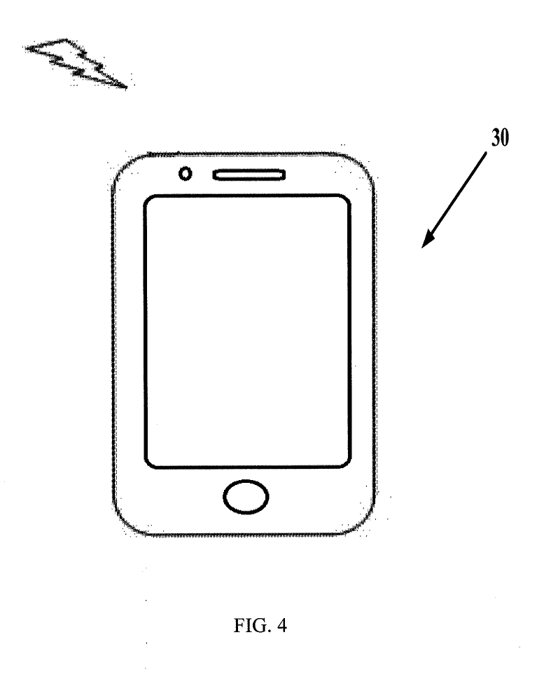

As shown in FIG. 3, the temperature measurement means 20 includes a controller 21, a power supply module (e.g., a battery) 22 coupled to the controller 21, a temperature sensor 23 and a transmitter 24. The transmitter 24 may further include a wireless module 25 and an antenna 26 connected to the wireless module 25. The temperature sensor 23 is configured to measure the temperature of the human body and may transfer the measurement data to the controller 21. After receiving the measurement data, the controller 21 may further send, at a prescribed time or in response to an external signal, the measurement data to an external receiver 30 (see FIG. 4) through the transmitter 24. The wireless module 25 may be a Bluetooth module, a WiFi module, or any other suitable wireless module.

The power supply module 22 may also be implemented as a module capable of collecting ambient energy, which can transform the energy of other forms generated on the human body, such as friction, pressure and temperature difference, into electricity.

In addition, the temperature sensor 23 may have a measuring accuracy of ±0.1° C. or less and a measuring range of 35° C. to 42° C.

Furthermore, the miniature wireless electronic thermometer may further include the receiver 30 that can read the temperature measurement data in a wireless manner and an application program installed in the receiver 30. Referring to FIG. 4, the receiver 30 may be a smartphone installed with the application program which may automatically read the temperature data and carry out statistics or analysis on the data. Further, the application program is desired to further have the ability to give an alarm when a read temperature value is deviated from a normal body temperature range, so as to render the thermometer suitable for use in body temperature monitoring in hospitalized patients.

### Embodiment 2

This embodiment differs from Embodiment 1 in that the receiver 30 is a laptop computer or tablet computer which is capable of reading the temperature measurement data wirelessly in a real-time, or temporally random or regular manner.

As such, a user can choose different data reading strategies for different purposes. For example, the user can choose the “real-time” strategy to record a continuous trend in the body temperature, or choose to read the measurement data any time as desired.

Moreover, when the user chooses the regular reading strategy, he/she can further designate a suitable reading interval to adapt for a specific application. For example, an interval of a half hour or an hour may be suitable for monitoring the body temperature of a child patient, while an interval of once every day in morning or before going to bed may be sufficient to monitor changes in the body temperature of a healthy person. Advantageously, this human-friendly design can serve more people and meet more needs.

### Embodiment 3

This embodiment differs from Embodiment 1 in that the receiver 30 is a special reader which can in turn control the thermometer of the invention to result in certain beneficial effects. For example, it can activate or deactivate the thermometer to for its more efficient use or for an extended service time per each service.

Moreover, the special reader may read the temperature data by means of remote control and subject the data to analysis performable by the application program installed therein. In addition, the special reader may further have an ability to automatically give an alarm if a read temperature value is deviated from a given range, or to subject the value to storage, accumulation and further analysis if it is within the range.

A contemplated application of this embodiment is in recording body temperature at a fixed time every day for a long term and creating a plot of body temperature versus time based on the records. This will be very helpful for many women who want to predict their ovulation based on a temporal trend in their body temperature in order to increase the possibility to get pregnant.

### Embodiment 4

In this embodiment, in order to prevent the occurrence of cross-infection during practical use of the thermometer, the thermometer itself, as a whole, or the securing means 10, may be a disposable article, and the temperature measurement means 20 may have a fully enclosed structure that can be entirely sterilized.

From the above description, it can be understood that the miniature wireless electronic thermometer of the present invention has the advantages of being capable of rapid and efficient measurement and monitoring of human body temperature in a convenient way and wireless transmission of the measurement data to an external receiver.

What is claimed is:

1. A miniature wireless electronic thermometer, comprising:
a temperature measurement means; and
a securing means configured to attach the temperature measurement means to a body part,
wherein the temperature measurement means is a non-interventional means and allows repeated temperature readings, the temperature measurement means comprising:
a temperature sensor;
a controller coupled to the temperature sensor and configured to control the temperature sensor to acquire a temperature measurement data;
a transmitter coupled to the controller and configured to transmit the temperature measurement data in a wireless manner; and
a power supply module configured to provide power to each of the temperature sensor, the controller and the transmitter.

2. The thermometer of claim 1, wherein the securing means is a medical adhesive tape.

3. The thermometer of claim 1, wherein the transmitter comprises a wireless module and an antenna coupled to the wireless module.

4. The thermometer of claim 1, wherein the power supply module is a battery.

5. The thermometer of claim 1, wherein the power supply module is a module capable of collecting an ambient energy.

6. The thermometer of claim 1, wherein the temperature sensor has a measuring accuracy of ±0.1° C. or less and a measuring range of 35° C. to 42° C.

7. The thermometer of claim 1, further comprising: a receiver configured to read the temperature measurement data in a wireless manner; and an application program installed in the receiver.

8. The thermometer of claim 7, wherein the receiver is one selected from the group consisting of a mobile phone, a laptop computer, a tablet computer and a special reader.

9. The thermometer of claim 8, wherein the receiver is configured to read the temperature measurement data by means of remote control, and the application program installed in the receiver is configured to analyze the read temperature measurement data and automatically give an alarm if the temperature measurement data is deviated from a preset range, or subject the temperature measurement data to storage, accumulation and further analysis if within the preset range.

10. The thermometer of claim 7, wherein the receiver is configured to read the temperature measurement data in a real-time manner, or a temporally random manner or a regular manner.

11. The thermometer of claim 1, wherein the thermometer, as a whole, is a disposable article.

12. The thermometer of claim 1, wherein the securing means is a disposable article, and the temperature measurement means has a fully enclosed and entirely sterilizable structure.

13. The thermometer of claim 1, wherein the wireless mode is a Bluetooth module or a WiFi module.
